(19) United States
(12) Patent Application Publication
(10) Pub. No.: US 2011/0231275 A1
(43) Pub. Date: Sep. 22, 2011

(54) SYSTEM AND METHOD FOR POSTING AND AUCTIONING ITEMS

(76) Inventor: Jonathan Sharaf, Great Neck, NY (US)

(21) Appl. No.: 12/831,481

(22) Filed: Jul. 7, 2010

Related U.S. Application Data
(60) Provisional application No. 61/314,707, filed on Mar. 17, 2010.

(51) Int. Cl. G06Q 30/00

(52) U.S. Cl. 705/26.3

(57) ABSTRACT

A method and system for providing on-line sale of items through electronic exchange of information. The system includes a host database configured and operative to store sales information pertaining to a plurality of items. The system is further configured to provide an on-line classified sales listing for each of the items stored in the host database at the discretion of a user. The system also provides an on-line auction for each of the items stored in the host database at the discretion of a user.

### FIELD OF THE INVENTION

The present invention relates to an auction system which provides an on-line auction process, and more particularly, to an automated auction selection process.

### BACKGROUND OF THE INVENTION

Motor vehicle auctions are well known in which motor vehicle dealers purchase at auction pre-owned motor vehicles. Motor vehicle auctions have become a popular way for motor vehicle dealers to add to their inventory of used vehicles which are sold at retail at their locations.

Currently, several large motor vehicle auction companies sell pre-owned vehicles. The pre-owned vehicles are assembled on one or more motor vehicle auction facilities. These pre-owned vehicles are consigned by motor vehicle manufacturers, rental car companies, commercial fleet companies, financial institutions, and motor vehicle dealers. In the past, full and effective participation in a commercial motor vehicle auction has meant that a representative of the motor vehicle dealer must personally visit the motor vehicle auction site to participate in the motor vehicle auction. This, of course, adds to the expense of purchasing vehicles in the motor vehicle auction and slows the entire process down.

Accordingly, some in the motor vehicle auction industry have attempted to stream-line the process by providing a way in which vehicle dealers can participate in the motor vehicle auction from remote locations, using some form of electronic on-line access to the motor vehicle auction itself. One such method is described in U.S. Pat. No. 6,006,201.

Even though the on-line auction process has now been streamlined with respect to the dealers, before our invention there was no method for dealers or public users to stream their data into live auctions through a method which automatically selects an auction based on pre-selected criteria.

It also still has the disadvantage of not offering classified sales processes for motor vehicles. This is because in some situations, it may be more advantageous for either a buyer or seller to engage in classified sales processes for buying or selling a motor vehicle. In such a situation, the buyer or seller is forced to go to another sales channel dedicated to such classified type of sales but have no means for conducting an auction for the motor vehicle.

Thus, it is an object of the present invention to provide an on-line process and system which offers both on-line classified and auction sales of motor vehicles as well as automatic auction selection.

### SUMMARY OF THE INVENTION

A method and system for providing on-line sale of a motor vehicle through electronic exchange of information. The system includes a host database configured and operative to store sales information pertaining to a plurality of motor vehicles. The system is further configured to provide an on-line classified sales listing for each of the motor vehicles stored in the host database at the discretion of a user for a motor vehicle. The system also provides an on-line auction for each of the motor vehicles stored in the host database at the discretion of a user for the motor vehicle.

In yet another illustrated embodiment of the invention a system and method for providing automated selection using of an auction using a host database to which to auction an item is provided. The method includes the steps of receiving descriptive information relating to an item to be auctioned in the host database and determining in the host database an appropriate auction in which to auction said item based upon computer analysis of the descriptive information. The item is then provided in the determined auction so as to be auctioned therefrom based on the determining step.

### BRIEF DESCRIPTION OF THE DRAWINGS

The objects and features of the invention may be understood with reference to the following detailed description of an illustrative embodiment of the present invention taken together in conjunction with the accompanying drawing in which:

FIG. 1 is a system level diagram of an illustrative embodiment of the present invention;

FIGS. 2-7 are screens shots of website pages depicting the method of use of the illustrative embodiment of the present invention depicted in FIG. 1; and

FIG. 8 depicts an alternative embodiment of the invention for automated the selection of auctions to post items thereto.

### DETAILED DESCRIPTION

The electronic motor vehicle sale system of the present invention provides interactive on-line services to remote users who may enter queries about vehicle sale information, sale schedules, classified sale pricing, auction pricing, and vehicle stock availability, and who may either “purchase” or “bid” for vehicles electronically. In an illustrated embodiment, the present invention system is implemented by connecting the users' personal computer workstations or electronic communications device, via communication networks, to the system host computer network.

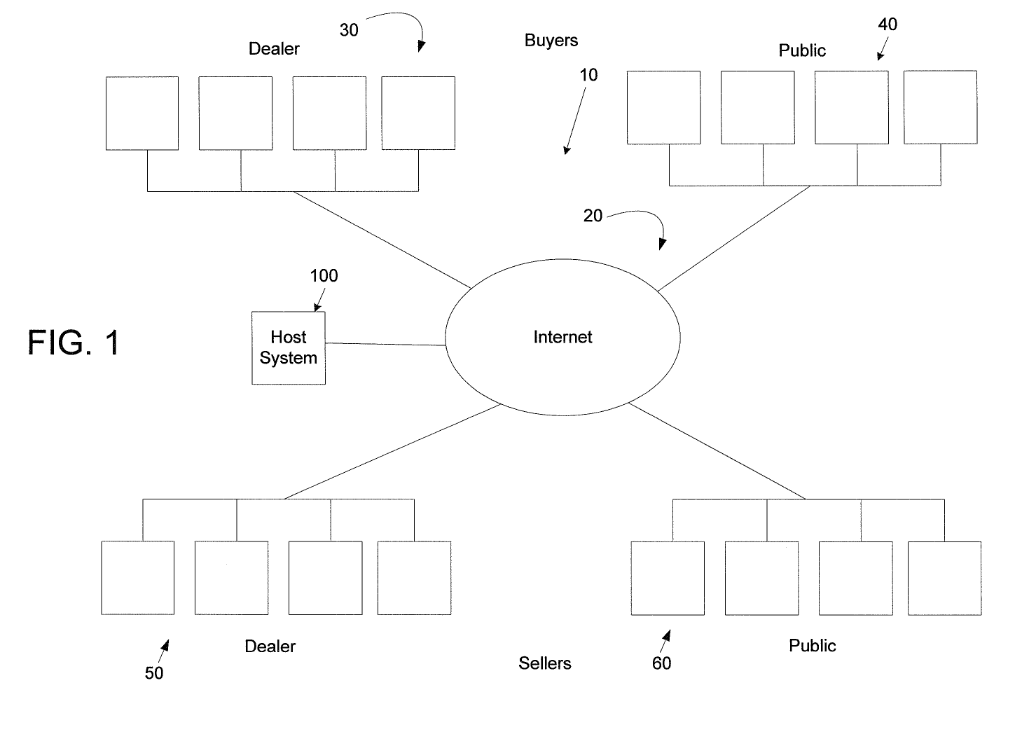

An exemplary architecture for the hardware used in the system of the present invention, designated generally by reference numeral 10, is shown in FIG. 1. Each user of the system 10 is preferably provided access to a computer, an exemplary configuration of which includes a workstation using an INTEL or AMD processor or compatible processor, with 8 megabytes of random access memory (RAM) running on Windows, LINUX or OSX software operating platform having an internet browser such as WINDOW's Explorer or OSX's Safari. It is also to be appreciated that a user of system 10 may access system 10 using an handheld device, including any type of PDA device (e.g., iPhone, Blackberry, Treo or the like) or virtually any type of device capable of establishing communicative connection with the Internet for exchanging information therewith.

Therefore, in the illustrative embodiment, the user's computing device will establish electronic connection to the host system 100 network through any known means of doing so, including via the internet 20 or through a network connection using asynchronous communications means. Preferably, all communications are established using known security techniques to prevent the compromise or intrusion of data communicated by users with the host system 100.

The host system 100 of the present invention preferably includes all software applications for performing the method of the present invention. The host system 100 further includes known database storage means for storing all data relating thereto.

Thus, it is to be appreciated that in the illustrative embodiment of the present invention system 10, the software specific for conducting classified on-line classified sales and auctions of motor vehicles (as discussed below) in accordance with the present invention resides on the host system 100. Thus, no specific software needs to be installed on a user's device, when such a user's device is configured to contain an internet web browser. In other words, a user will gain access to the software on host system 100 for facilitating the on-line sale and purchase of a motor vehicle in accordance with the present invention via a user's internet browser or other similar access for gaining remote access to a software application.

It is to be appreciated that there are several type of users to be associated with the illustrative embodiment of the present invention. Preferably, there are dealer buyers 30, public buyers 40, dealer purchasers 50 and public purchasers 60. It is to be understood that a “dealer” is to include businesses which sell new and used vehicles (including retail and wholesale) and also including captive finance companies and other commercial vehicle sellers. And public users are to be understood to include a member of the public who buys or purchases a motor vehicle whom is not directly engaged in the commercial business of buying and selling vehicles, whether retail or wholesale.

Once communication is established and security measures are passed, the only network activity that occurs are data queries from the users and responses from host network.

In a preferred embodiment of the illustrative embodiment of the present invention depicted by system 10, the host system application 100 is preferably developed and coded in a manner well known to those skilled in the art, using event-driven program language, which indicates that program directions are executed based on the activity of a user such as a key press, or mouse click. Because typical programming is based on an “event driven” environment, there is not defined flow of program. In event driven applications, all programming is based on defining the response to the event. Consequently, any drawing figures which illustrate program flow for the various applications of the system are not intended to show traditional program logic. Rather, any flow charts assume that the user makes specific selections, then describe an overall flow of what takes place when certain events are triggered.

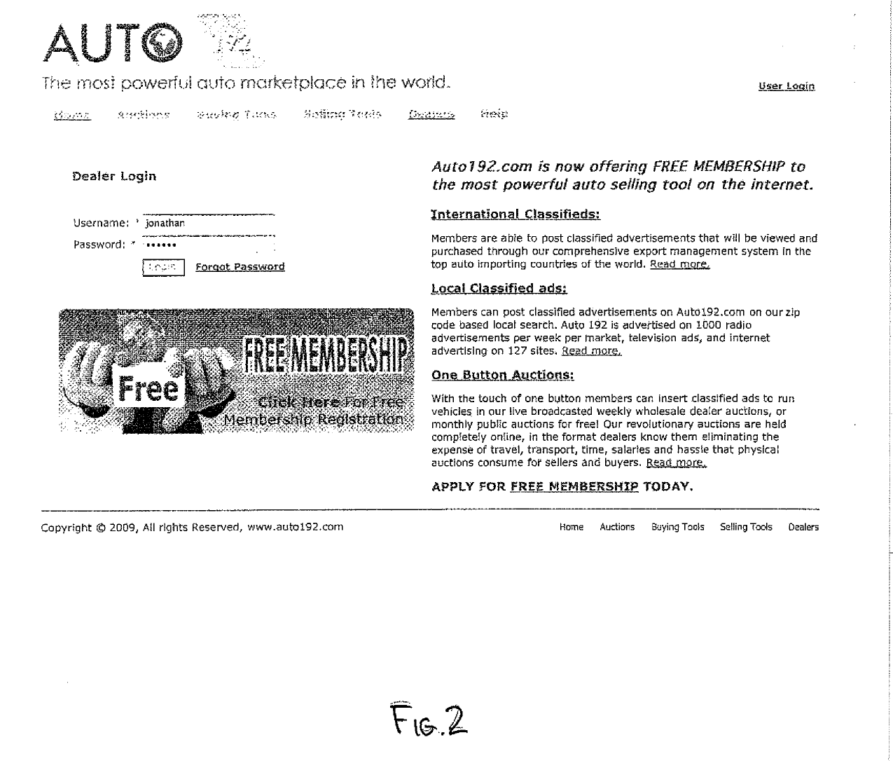

With reference to FIG. 2, to begin using the on-line motor sale and auction system, a user activates his or her electronic device by establishing Internet connection with host system 100 preferably via the internet 20. After such communication is established, preferably a sign-on screen will appear. At this point, the user preferably enters their username and password which is preferably pre-selected by the user.

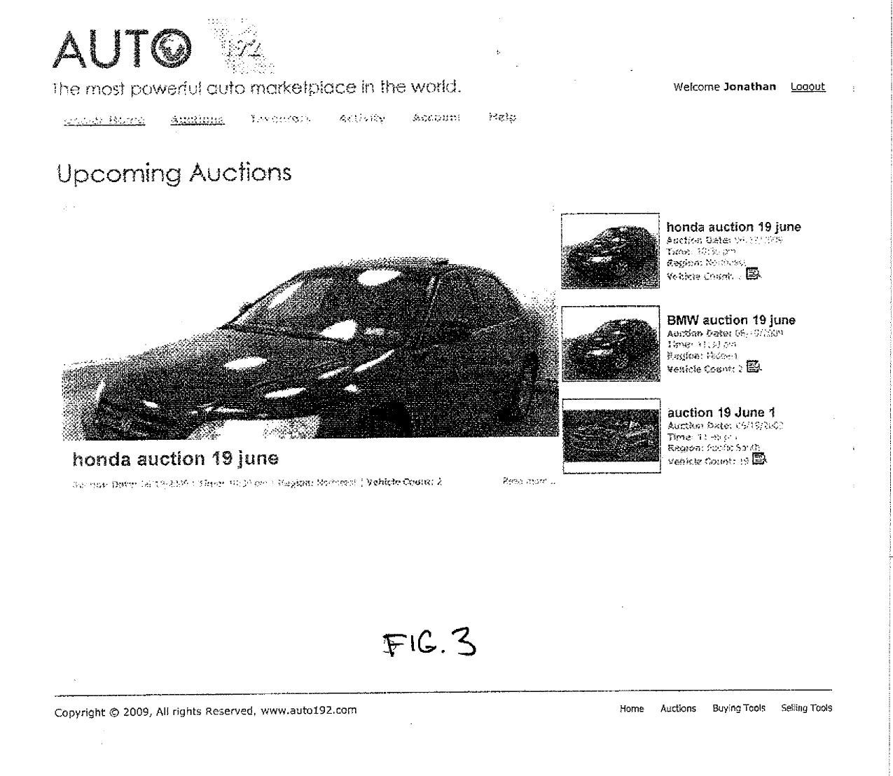

With reference now to FIG. 3, when the host system accepts a user's login information, and depending upon the type of user, the user is enabled to 1) post a motor vehicle for sale; 2) post a motor vehicle for auction, 3) select to purchase a motor vehicle for sale from classified listings or 4) select to purchase a motor vehicle for sale from an auction to be conducted by host system 100.

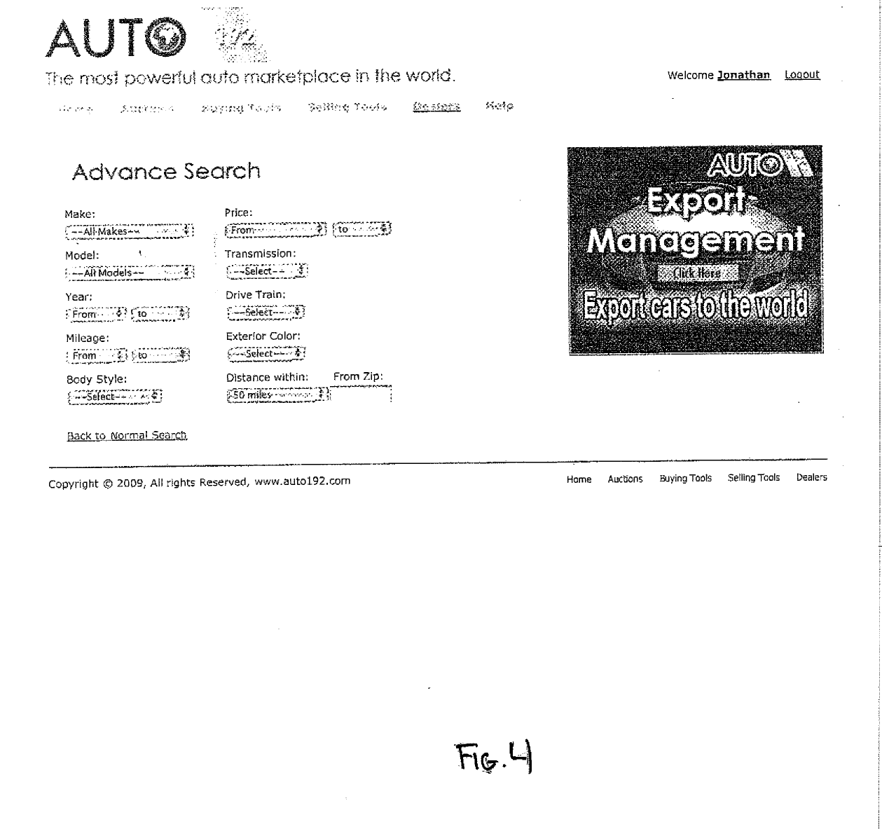

When a user desires to browse the classified inventory of vehicles posted for sale, the host system provides a screen similar to that depicted in FIG. 4 wherein the a user may search for a motor vehicle listed for sale in classified sales contained in the host systems based on some or all of the following fields:
1. Make
2. Model
3. Year
4. Mileage
5. Body Style
6. Price
7. Transmission Type
8. Drive Train Type
9. Exterior Color
10. Distance the vehicle is for sale from user location.

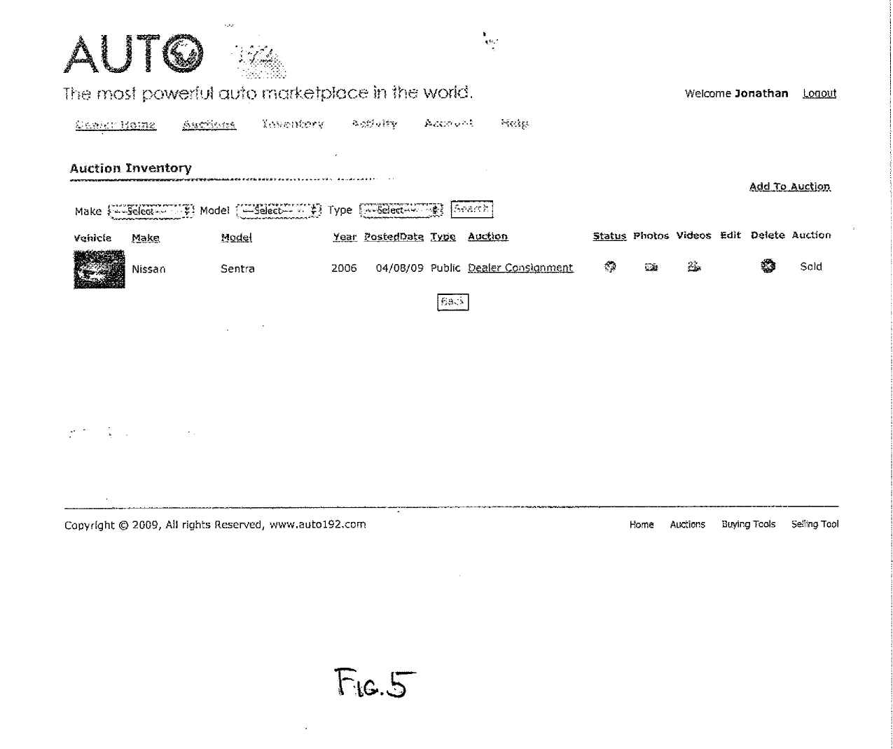

Similarly when a user desires to browse the inventory of vehicles posted for auction, the host system 100 provides a screen similar to that depicted in FIG. 5 wherein a user may search for a motor vehicle listed for auction to be conducted on a prescribed date by the host system 100. The user is able to search vehicles to be auctioned based on the following criteria: Make, Model and Vehicle Type. In response to the user's search criteria, the auction search results provided by the host system 100 may include:
1. A picture of the vehicle
2. Vehicle make
3. Model of vehicle
4. Vehicle year
5. Date vehicle was posted for Auction
6. Auction Type
7. Auction Status
8. Additional photos of vehicle
9. Videos of vehicle
10. Availability of vehicle

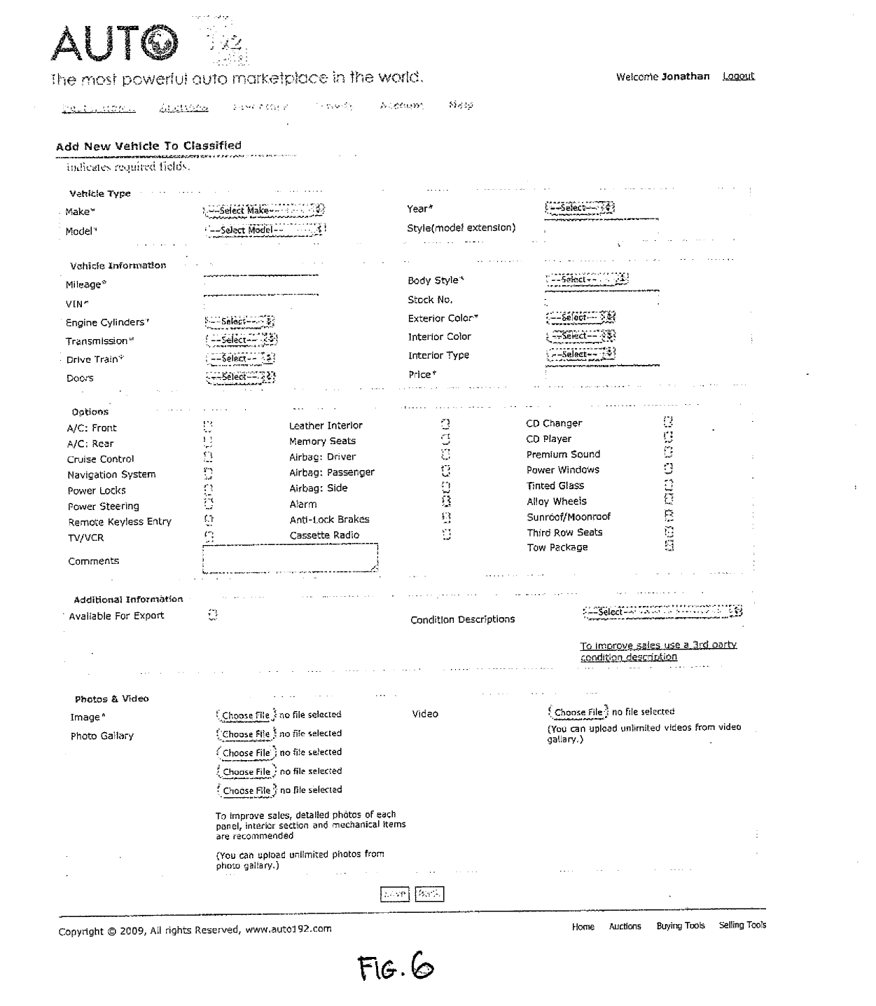

With reference now to FIG. 6, when a user desires to use host system 100 to post a vehicle for sale in a classified listing by host system 100, host system 100 is preferably operative to input the following categories 1) Vehicle Type; 2) Vehicle Information; 3) Vehicle Options 4) Additional Information and 5) Photos & Video of the Vehicle.

With respect to each aforesaid category, the following category information my be input and stored in host system 100:

### Vehicle Type

1. Make
2. Model
3. Vehicle year
4. Vehicle style

### Vehicle Information

1. Mileage
2. Vehicle VIN
3. Number of engine cylinders
4. Transmission type
5. Drive Train type
6. Number of vehicle doors
7. Vehicle body style
8. Vehicle stock no.
9. Exterior color
10. Interior color
11. Interior type
12. Vehicle Price

### Vehicle Options

1. A/C front
2. A/C rear
3. Cruise Control
4. Navigation System
5. Power Locks
6. Power Steering
7. Remote Keyless Entry
8. TV/VCR
9. Leather interior
10. Memory seats
11. Airbag: Driver
12. Airbag: Passenger
13. Airbag: Side
14. Alarm
15. Anti-Lock brakes
16. Cassette Radio
17. CD Changer
18. CD Player
19. Premium Sound
20. Power Windows
21. Tinted Glass
22. Alloy Wheels
23. Sunroof/Moonroof
24. Third Row Seats
25. Tow Package
26. Additional User Comments on Vehicle Options

### Additional Information

1. Is Vehicle available for export
2. Vehicle Condition Description

It is noted that with respect to a vehicle condition report, the host system 100 of the present invention is operative to enable a user to use and import a third party condition description report.

### Photos & Video

1. Multiple photos of the users vehicle for sale may be posted to host system 100
2. Multiple videos of the users vehicle for sale may be posted to host system 100

Thus, once the above information is input to host system 100, all of the information may be used by host system 100 for creating and conducting a classified sale listing process for a user's vehicle as described above with reference to FIG. 4.

It is to be appreciated that host system 100 may provide a buy now feature in which a buyer user simply selects a “buy now” button associated with a vehicle classified sale listing to purchase the vehicle from the user seller.

Additionally, the host system 100 of the present invention is operative to automatically convert a classified sale listing to an auction listing (as described below) by having a seller user simply pressing a “auction” button associated with a vehicle classified sale listing. It is noted that the host system may be further configured to automatically convert a classified sale listing to an auction listing (as described below) upon the happening upon some prescribed threshold event such as the motor vehicle is not sold by a date certain from its posting in the classified sales listing described above. When a listed vehicle is converted from a classifies sale to an auction sale, preferably all the information inputted by a user above associated with establishing a classified sale listing for a motor vehicle is transferred to establishing an auction sale for the motor vehicle. The only additional information that may be supplemented to complete the transition to an auction on auction announcement data associated with the motor vehicle.

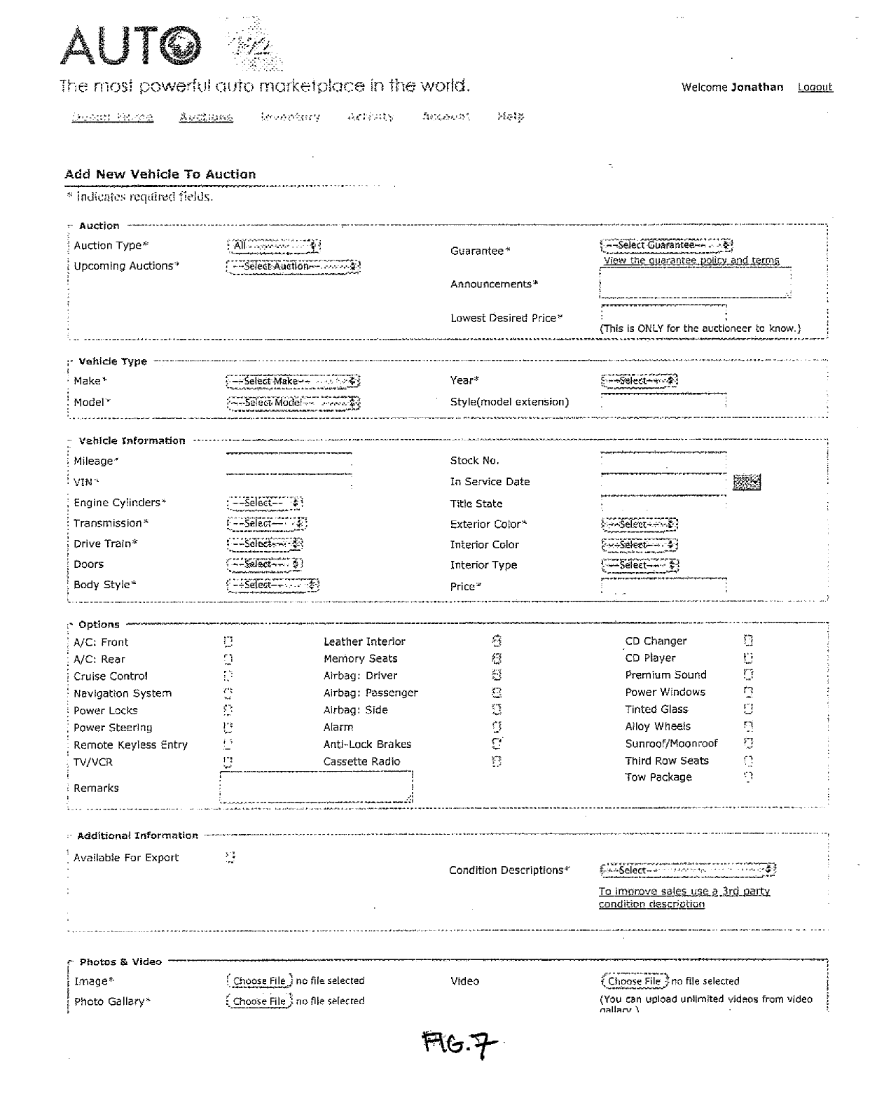

With reference now to FIG. 7, when a user desire to use host system 100 to post a vehicle for auction by host system 100, host system 100 is preferably operative to input the following categories 1) Auction; 2) Vehicle Type; 3) Vehicle Information 4) vehicle Options 5) Additional Vehicle Information and 5) Photos & Video.

With respect to each aforesaid Auction category, the following category information my be input and stored in host system 100:

### Auction

1. Auction Type—preferably there will be two types of auctions to be conducted by host system 100, a public auction and a dealer auction. In a public auction, the seller users vehicle is inserted in an auction open to both public and dealer buyer users and in a dealer auction, the sellers user vehicle is inserted in an auction open to only dealer buyer users.
2. Upcoming Auctions—this selection is operative to enable a seller user to select which upcoming auction to be hosted by the host system 100 in which the seller users vehicle is to be auctioned within. This selection can be based on date and time constraints.
3. Guarantee—will the seller user be providing a guarantee on the vehicle to be auctioned.
4. Announcements—includes a description of any know defects associated with the vehicle (e.g., physical damage, defective title, etc.)
5. Lowest Desired Price (Preferably only the auctioneer will know this information)

### Vehicle Type

1. Make
2. Model.
3. Vehicle year
4. Vehicle style

### Vehicle Information

1. Mileage
2. Vehicle VIN
3. Number of engine cylinders
4. Transmission type
5. Drive Train type
6. Number of vehicle doors
7. Vehicle body style
8. Vehicle stock no.
9. Exterior color
10. Interior color
11. Interior type
12. Vehicle Price

### Vehicle Options

1. A/C front
2. A/C rear
3. Cruise Control
4. Navigation System
5. Power Locks
6. Power Steering
7. Remote Keyless Entry
8. TV/VCR
9. Leather interior
10. Memory seats
11. Airbag: Driver
12. Airbag: Passenger
13. Airbag: Side
14. Alarm
15. Anti-Lock brakes
16. Cassette Radio
17. CD Changer
18. CD Player
19. Premium Sound
20. Power Windows
21. Tinted Glass
22. Alloy Wheels
23. Sunroof/Moonroof
24. Third Row Seats
25. Tow Package
26. Additional User Comments on Vehicle Options

### Additional Information

1. Is Vehicle available for export
2. Vehicle Condition Description

It is noted that with respect to a vehicle condition report, the host system 100 of the present invention is operative to enable a user to use a third party condition description report.

### Photos & Video

1. Multiple photos of the users vehicle for sale may be posted to host system 100
2. Multiple videos of the users vehicle for sale may be posted to host system

It is noted that in accordance with this illustrative embodiment of the present invention, the host system is operative to conduct an auction with either live audio or automated audio. In a live auction, an actually human auctioneer will be conducting the auction in which the auctioneer's voice (preferably in addition to video data) will be sent to each buyer user's device to create a live auction-like environment. Alternatively, a automated voice may be used wherein the host system 100, in response to buyer user feedback, will provide the responsive automated audio in a chosen language—thus an auction can be conducted in multiple languages without requiring multiple auctioneers.

It is further to be appreciated that host system 100 is operative to provide communication between a user seller and the auctioneer during an auction for a user seller's vehicle. Thus, a user seller can make adjustments to an auction posting even during an auction process (e.g., lower the starting bid price for a vehicle). Further, the host system may be operative to allow a user seller to accept a bid price after the conclusion of the auction if the bid price was below the reserve price. This option may be available to the user seller for a predetermined amount of time (e.g., a day) wherein the bidder will be obligated to buy the user seller's vehicle if the user seller accepts the bid that is below the reserve price.

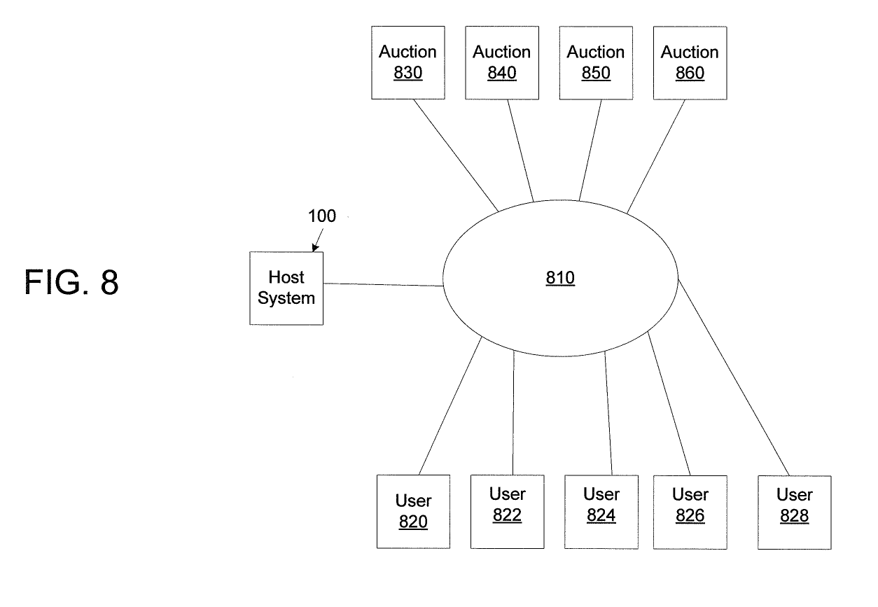

With reference now to FIG. 8, a screen shot depicting a live auction conducted by host system 100 is depicted which is used by a buyer user. The display screen of FIG. 8 is preferably operative to display:

### 1—The Auction Name;

2—The auction number associated with the vehicle currently under auction;
3—Photographs of the vehicle currently under auction;
4—Videos of the vehicle currently under auction;
5—Details vehicle currently under auction including;
a. Make
b. Model
c. Year
d. Mileage
e. VIN number
f. Vehicle Color
g. Title state of vehicle
h. Engine type
i. Transmission type
j. Vehicle Condition Report
   6—Seller information;
   7—Chat/Message box to send messages to Auctioneer
   8—BID button—operative for user seller to submit a bid at the quoted Asking Bid;
   9—Listing of upcoming vehicles to be auctioned.

The present invention host system 100 is preferably further operative to provide export shipping of vehicles purchased by users on the host system 100. The present invention is additionally further operative to preferably provide arbitration services between user buyers and user sellers using host system associated with the buying and selling of vehicles via host system 100.

With reference now to FIG. 8, there is shown another embodiment of the invention wherein the host system 800 is operative to distribute auction data from one of a plurality of remote users 820 to an appropriate auction, preferably via matching specific dates and times that are either pre-existing or newly generated according to pre-selected criteria by a user 820 as described further below.

As shown, host system 800 is connected to a plurality of users 820-828 and to a plurality of auctions 830-860, each having appropriate computer processing means for connecting, and communicating, with host system 800, preferably via the internet 810.

In use, when a user 820-828 desires to post an item for sale in an auction 830-860, the user, preferably via the internet and a website portal, enters data relating to the item to be auctioned and auction criteria, wherein such data includes the geographic region the item is to be auctioned, an auction date range and/or specific date, the specifics of the item to be sold (e.g., description, age, wear, color, size, etc.) and the seller type (e.g., commercial private etc.). Once this data is entered to host system 800, host system 800 is operative and configured, preferably via an analytical algorithm, to selected an auction connected thereto that best matches with the users entered auction data as described above. Once an auction 830-860 is selected, the users item is then posted therein for auction at the appropriate time.

In the event host system 800 determines there is no appropriately matching auction, it is to be understood host system 800 is operative and configured to generate an appropriate auction to which to post the user's item for sale. It is also to be understood that if the user has a plurality of items to be posted for auction, the user may enter the aforesaid data for all items so they are batched by host system 800 for selecting an appropriate auction thus obviating the need to perform this separately for each item. It is further to be understood that a user cab preset these preferences so that third party data feeds will automatically distribute auction data whereby a system administrator may change the available criteria for users to select.

It is to be appreciated that while an item to be listed for auction in the illustrated embodiment of FIG. 8 may be an automobile, it is not understood to be limited thereto as it may encompass any item capable of being sold via an auction process.

Host system 800 may be further configured and operable to provide distribution of requests for generating inspection orders to a proper third party and/or system administrator according to preset preferences and administrative capabilities for accepting or rejecting an auction sale and posting a final report for the item.

The aforesaid method for generating inspection orders includes:
1—a user purchasing an item via an auction;
2—a user ordering post sale inspection from system 800;
3—an inspection request is distributed, preferably via host 800, to a proper administrator, preferably according to preset preferences (which can include geographic location and like criteria);
4—an administrator either accepts or rejects the item online, and posts the report which can be viewed by all involved parties.

It is to be appreciated that although there have been described particular embodiments of the present invention of a new and useful electronic system and method for selling motor vehicles either through classified sale listings or auction listings, it is not intended that such references be construed as limitations upon the scope of the present invention except as set forth in the following claims.

What is claimed is:

1. A system for providing on-line sale of a motor vehicle through electronic exchange of information, said system comprising a host database configured and operative to:
store information pertaining to a plurality of motor vehicles;
provide an on-line classified sale listing for each of said motor vehicles stored in said host database at the discretion of a user for said motor vehicle; and
provide an on-line auction for each of said motor vehicles stored in said host database at the discretion of a user for said motor vehicle.

2. The system as recited in claim 1 wherein said host database is further configured and operative to convert an on-line classified sale listing to an on-line auction for a said motor vehicle.

3. The system as recited in claim 2 wherein said host database is further configured and operative to convert an on-line classified sale listing to an on-line auction for a said motor vehicle upon the instruction of a user.

4. The system as recited in claim 2 wherein said host database is further configured and operative to convert an on-line classified sale listing to an on-line auction for a said motor vehicle upon the happening of a predetermined event.

5. The system as recited in claim 1 wherein said host database is further configured and operative to provide user input relating to the condition of an automobile using a third party system.

6. The system as recited in claim 1 wherein said host database is further configured and operative to provide export shipping of motor vehicles associated with said host database.

7. The system as recited in claim 1 wherein said system further includes means for providing arbitration settlement between buyers and sellers of motor vehicles associated with said host database.

8. A method for providing on-line sale of a motor vehicle through electronic exchange of information, said method comprising the steps of:
providing a host database;
storing sale information in said host database pertaining to a plurality of motor vehicles;
selectively providing an on-line classified sale listing on a user terminal for each of said motor vehicles stored in said host database; and
selectively providing an on-line auction on a user terminal for each of said motor vehicles stored in said host database.

9. The method as recited in claim 8 further including the step of converting in said host database an on-line classified sale listing to an on-line auction for a said motor vehicle.

10. The method as recited in claim 9 further including the step of converting in said host database an on-line classified sale listing to an on-line auction for a said motor vehicle is performed upon the instruction of a user.

11. The method as recited in claim 9 further including the step of converting in said host database an on-line classified sale listing to an on-line auction for a said motor vehicle is performed upon the happening of a predetermined event.

12. The method as recited in claim 8 further including the step of providing user input to said host database relating to the condition of an automobile using a third party system.

13. The method as recited in claim 8 further including the step of providing export shipping of motor vehicles associated with said host database.

14. The method as recited in claim 8 further including the step of providing arbitration settlement between buyers and sellers of motor vehicles associated with said host database.

15. A method for providing automated selection of an auction using a host database to which to auction an item, said method comprising the steps of:
receiving descriptive information relating to an item to be auctioned in said host database;
determining in said host database an appropriate auction in which to auction said item based upon computer analysis of said descriptive information;
providing said item in said determined auction to auction said item based on said determining step.

16. A system as recited in claim 15 further including the steps of:
providing a plurality of live auctions to be conducted by said host database with each auction to be conducted at a specific time and date; and
choosing from one said plurality of live auctions by a user which is to auction a user's vehicle.

17. A method as recited in claim 15 further including the step of conducting the live auction as a computer controlled event using an automated auctioneer.
